(19) United States
(12) Patent Application Publication
(10) Pub. No.: US 2025/0266759 A1
(43) Pub. Date: Aug. 21, 2025

(54) CHARGE PUMP, CHARGE PUMP SYSTEM, AND METHOD OF CONTROLLING A CHARGE PUMP

(71) Applicant: OMNIVISION TECHNOLOGIES, INC., Santa Clara, CA (US)

(72) Inventor: Kwang-Hyun LEE, Kanagawa (JP)

(21) Appl. No.: 18/821,508

(22) Filed: Aug. 30, 2024

(30) Foreign Application Priority Data
Feb. 21, 2024 (JP) 2024-024200

(51) Int. Cl. H02M 3/07; H02M 1/00

(52) U.S. Cl. CPC H02M 3/07; H02M 1/0095

(57) ABSTRACT

A charge pump includes a flying capacitor; a push-pull driver connected to a first end of the flying capacitor; a first switch provided between the first end of the flying capacitor and a first reference conductor; a second switch provided between a second end of the flying capacitor and the first reference conductor; and a third switch provided between the second end of the flying capacitor and an output terminal. The push-pull driver includes a fourth switch and a fifth switch, each of the fourth switch and the fifth switch having a first end connected to the first end of the flying capacitor. The fourth switch has a second end connected to a second reference conductor, the second reference conductor being different from the first reference conductor. The fifth switch has a second end connected to the first reference conductor.

### CROSS REFERENCE TO RELATED APPLICATION

This application claims priority to Japanese Patent Application No. 2024-24200 filed on Feb. 21, 2024, which is incorporated herein by reference in its entirety including the specification, claims, drawings, and abstract.

### TECHNICAL FIELD

The present disclosure relates to a charge pump, a charge pump system, and a method of controlling a charge pump, and, in particular, relates to improvements thereof.

### BACKGROUND

Image sensors such as CMOS image sensors are widely used. Typically, an image sensor has a structure including multiple pixels arranged in multiple rows and columns. For each of the pixels, a transistor is used. Transistors in the pixels are individually controlled by a driver circuit, so that pixel values for the pixels are controlled. For the driver circuit, a charge pump is used, and the charge pump provides a control voltage which is output from the driver circuit to the pixels.

As art relevant to the present disclosure, Patent Literature 1 and Non-Patent Literature 1 identified below disclose charge pumps. Non-Patent Literature 2 discloses a technique of generating a control signal for feedback control in accordance with the difference between two input voltages.

### CITATION LIST

### Patent Literature

Patent Literature 1: U.S. Pat. No. 5,546,296

### Non-Patent Literature

Non-Patent Literature 1: J. Y. Lee, et. al., “A Regulated Charge Pump With Small Ripple Voltage and Fast Start-Up,” in IEEE Journal of Solid-State Circuits, Vol. 41, No. 2, February 2006.
Non-Patent Literature 2: R. Hogervorst, et. al, “A Compact Power-Efficient 3 V CMOS Rail-to-Rail Input/Output Operational Amplifier for VLSI Libraries,” IEEE Journal of Solid-State Circuits, Vol. 29, No. 12, December 1994.

### SUMMARY

Typically, an image sensor includes readout signal lines for reading pixel values from pixels, the readout signal lines being arranged in multiple columns. A readout signal line may be coupled to a conductor line, that connects between pixels and a driver circuit, via stray capacitance. As a result, the voltage of the readout signal line may affect the operation of the driver circuit and the pixels, causing an artifact to appear in an image shown by the image sensor.

A charge pump may be required to provide the pixel control voltage which is higher than the power supply voltage or lower than the ground voltage. However, a conventional charge pump as described in, for example, Patent Literature 1 or Non-Patent Literature 1 may be unable to control the voltage output to the pixels relative to the potential of a grounded conductor in both positive and negative polarities, making appropriate control difficult and causing image artifacts.

The present disclosure is directed toward providing a charge pump for controlling an image sensor appropriately.

According to an aspect of the present disclosure, there is provided a charge pump comprising a flying capacitor; a push-pull driver provided on a first end of the flying capacitor; a first switch provided between the first end of the flying capacitor and a first reference conductor; a second switch provided between a second end of the flying capacitor and the first reference conductor; and a third switch provided between the second end of the flying capacitor and an output terminal. The push-pull driver comprises a fourth switch and a fifth switch, each of the fourth switch and the fifth switch having a first end connected to the first end of the flying capacitor. The fourth switch has a second end connected to a second reference conductor, the second reference conductor being different from the first reference conductor, and the fifth switch has a second end connected to the first reference conductor.

According to another aspect of the present disclosure, there is provided a charge pump system comprising a plurality of charge pumps, each of the plurality of charge pumps comprising a flying capacitor; a push-pull driver provided on a first end of the flying capacitor; a first switch provided between the first end of the flying capacitor and a first reference conductor; a second switch provided between a second end of the flying capacitor and the first reference conductor; and a third switch provided between the second end of the flying capacitor and an output terminal. The push-pull driver comprises a fourth switch and a fifth switch, each of the fourth switch and the fifth switch having a first end connected to the first end of the flying capacitor. The fourth switch has a second end connected to a second reference conductor, the second reference conductor being different from the first reference conductor, and the fifth switch has a second end connected to the first reference conductor. The output terminals of the plurality of charge pumps are connected in common. A clock signal for controlling the first to fifth switches included in each of the plurality of charge pumps is input to each of the plurality of charge pumps. The clock signal has a different phase for each of the plurality of charge pumps.

According to still another aspect of the present disclosure, there is provided a method of controlling a charge pump, the charge pump comprising a flying capacitor; a push-pull driver provided on a first end of the flying capacitor; a first switch provided between the first end of the flying capacitor and a first reference conductor; a second switch provided between a second end of the flying capacitor and the first reference conductor; and a third switch provided between the second end of the flying capacitor and an output terminal. The push-pull driver comprises a fourth switch and a fifth switch, each of the fourth switch and the fifth switch having a first end connected to the first end of the flying capacitor. The fourth switch has a second end connected to a second reference conductor, the second reference conductor being different from the first reference conductor, and the fifth switch has a second end connected to the first reference conductor. The method comprises alternately turning the first switch and the second switch ON or OFF; turning the third switch ON or OFF together with the first switch; and turning the fourth switch and the fifth switch ON or OFF together with the second switch.

The present disclosure provides a charge pump for controlling an image sensor appropriately.

### BRIEF DESCRIPTION OF DRAWINGS

Embodiments of the present disclosure will be described based on the following figures, wherein:

FIG. 1 illustrates a charge pump according to a basic configuration of the present disclosure;

FIG. 2 illustrates a relationship between an output voltage and time;

FIG. 3 illustrates control characteristics of a current source;

FIG. 4 illustrates a charge pump according to an embodiment of the present disclosure;

FIG. 5 illustrates time waveforms of a clock signal and an inverted clock signal;

FIG. 6 illustrates time waveforms of an offset clock signal and an offset inverted clock signal;

FIG. 7 illustrates a push-pull driver together with a portion of an error amplifier;

FIG. 8 illustrates a configuration for a case where voltage-shifting power supplies are removed;

FIG. 9 illustrates a relationship between a charging current of a flying capacitor and a control voltage;

FIG. 10 illustrates a relationship between a charging current of a flying capacitor and a control voltage;

FIG. 11 illustrates a voltage-shifting circuit;

FIG. 12 illustrates a charge pump system according to a first application embodiment of the present disclosure;

FIG. 13 illustrates a charge pump system according to a second application embodiment of the present disclosure;

FIG. 14 illustrates a charge pump according to a modification example of the present disclosure; and

FIG. 15 illustrates a voltage-shifting circuit.

### DESCRIPTION OF EMBODIMENTS

Embodiments of the present disclosure will be described below with reference to the drawings. The same components illustrated in two or more drawings are denoted by the same reference numerals, and the description thereof is simplified. Directional terms, such as upper and lower, as used herein represent directions as viewed in the drawings. These directional terms are used for ease of description and should not be understood as limiting how components are arranged.

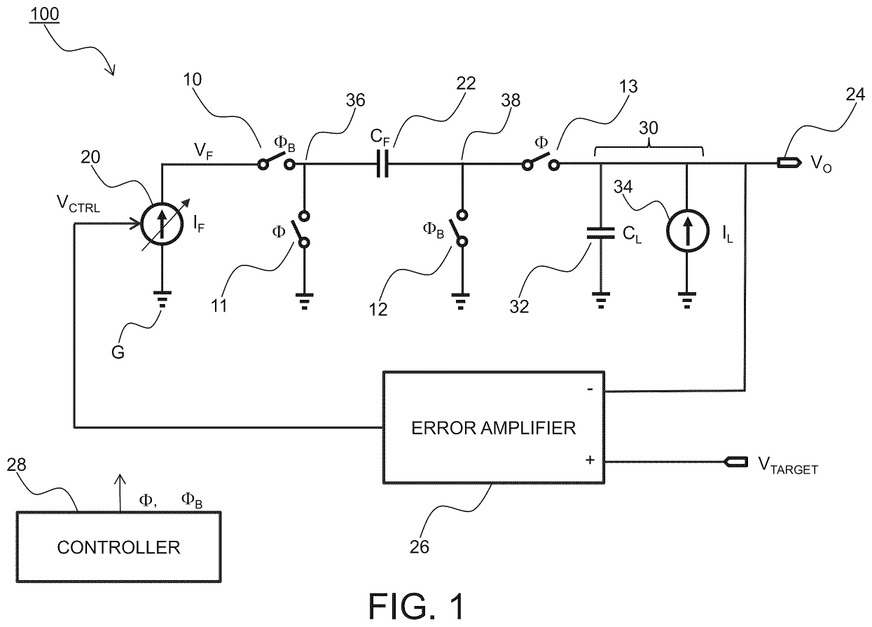

FIG. 1 illustrates a charge pump 100 according to a basic configuration of the present disclosure. The charge pump 100 includes a current source 20, a driver switch 10, a first switch 11, a flying capacitor 22, a second switch 12, a third switch 13, an output terminal 24, an error amplifier 26, and a controller 28.

A grounding terminal of the current source 20 is connected to a grounded conductor G. A first end of the driver switch 10 is connected to a positive electrode terminal of the current source 20. A second end of the driver switch 10 is connected to a first end 36 of the flying capacitor 22.

The first switch 11 is connected between the first end 36 of the flying capacitor 22 and the grounded conductor G. The second switch 12 is connected between a second end 38 of the flying capacitor 22 and the grounded conductor G. A load circuit 30 includes a load capacitor 32 and a load current source 34 that are connected in parallel with each other. The third switch 13 is connected between the second end 38 of the flying capacitor 22 and an upper end of the load circuit 30.

The error amplifier 26 outputs, to the current source 20, a control voltage V_{CTRL} that reduces the magnitude of a difference value obtained when an output voltage Vo from the upper end of the load circuit 30 is subtracted from a target voltage V_{TARGET}.

The controller 28 may include a processor serving as hardware that executes a program, thereby controlling a charge pump 102. The controller 28 may include a memory that stores a program. The driver switch 10 and the second switch 12 are simultaneously controlled ON or OFF in response to a control signal Φ_{B} output from the controller 28. The first switch 11 and the third switch 13 are simultaneously controlled OFF or ON in response to a control signal Φ output from the controller 28. The set of the driver switch 10 and the second switch 12, and the set of the first switch 11 and the third switch 13, are alternately turned ON or OFF. In the following description, an operation phase in which the driver switch 10 and the second switch 12 are ON is referred to as Φ_{B} phase, and an operation phase in which the first switch 11 and the third switch 13 are ON is referred to as Φ phase.

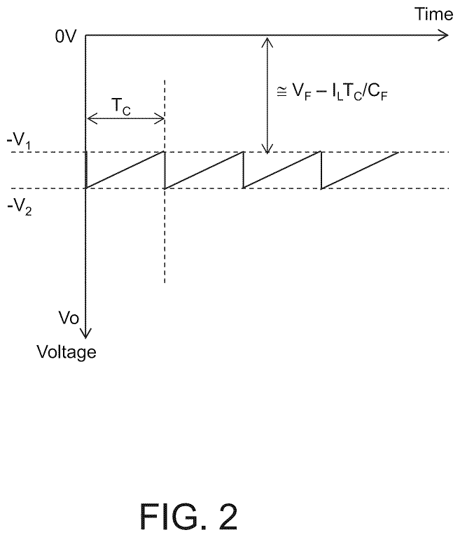

The operation of the charge pump 100 will be described below. FIG. 2 illustrates a relationship between an output voltage Vo and time. The horizontal axis represents time, and the vertical axis represents output voltage Vo. After the Φ_{B} phase is maintained for a period of time Tc/2, the operation phase changes to the Φ phase, the operation phase is then maintained in the Φ phase for a period of time Tc/2, and this sequence operation is repeated. In the PB phase, the output voltage Vo increases until Vo=−V₁, and in the Φ phase, the output voltage Vo becomes Vo=−V₂.

Assume that the capacitance of the flying capacitor 22 is C_{F} and that the capacitance of the load capacitor 32 is C_{L}. In the Φ_{B} phase, if the electric charge charged into the flying capacitor 22 is C_{F}·V_{F} and the electric charge charged into the load capacitor 32 is C_{L}·V₁, it is assumed that the flying capacitor 22 has a terminal-to-terminal voltage V_{F} and the load capacitor 32 has a terminal-to-terminal voltage V₁.

In the Φ phase, if the electric charge charged into the flying capacitor 22 is C_{F}·V₂ and the electric charge charged into the load capacitor 32 is C_{L}·V₂, it is assumed that each of the flying capacitor 22 and the load capacitor 32 has a terminal-to-terminal voltage V₂.

According to principle of conservation of charge, the summation value of the electric charge that is charged into the flying capacitor 22 and the electric charge that is charged into the load capacitor 32 in the Φ_{B} phase, C_{F}·V_{F}+C_{L}·V₁, becomes equal to the summation value of the electric charge that is charged into the flying capacitor 22 and the electric charge that is charged into the load capacitor 32, C_{F}·V₂+C_{L}·V₂, immediately after the Φ phase begins. Therefore, the following equation (1) holds.

$${C}_{F} \cdot {V}_{F} + {C}_{L} \cdot {V}_{1} = {C}_{F} \cdot {V}_{2} + {C}_{L} \cdot {V}_{2} \qquad ( 1 )$$

By solving equation (1) with respect to −V₂, the following equation (2) is obtained.

$$- {V}_{2} = - ( {C}_{F} \cdot {V}_{F} + {C}_{L} \cdot {V}_{1} ) / ( {C}_{F} + {C}_{L} ) \qquad ( 2 )$$

As can be understood from the above, the output voltage in the Φ phase, Vo=−V₂, is represented using the output voltage in the Φ_{B} phase, Vo=−V₁.

When the load current I_{L} flowing into the load current source 34 is not 0, the electric charge Q supplied to the load capacitor 32 during the Φ_{B} phase is represented by the following equation (3).

$$Q = {C}_{L} ( - {V}_{1} - ( - {V}_{2} ) ) = {C}_{F} \cdot ( {V}_{F} - {V}_{1} ) \cdot {C}_{L} ( {C}_{F} + {C}_{L} ) \qquad ( 3 )$$

The electric charge Q is equal to a change in output voltage Vo during time Tc, −V₁−(−V₂), multiplied by the capacitance C_{L} of the load capacitor 32. In other words, the electric charge Q is supplied to the load capacitor 32 in an amount corresponding to a change in terminal-to-terminal voltage of the load capacitor 32, and the load current I_{L} is obtained by dividing the electric charge Q by time Tc.

$${I}_{L} = Q / Tc = {C}_{L} \cdot {C}_{F} \cdot ( {{V}_{F}}_{{-}^{}} {V}_{1} ) / ( {C}_{F} + {C}_{L} ) / Tc \qquad ( 4 )$$

By solving equation (4) with respect to −V₁, the voltage −V₁ which the output voltage Vo reaches in the Φ_{B} phase is obtained.

$$- {V}_{1} \approx - {V}_{F} + {I}_{L} \cdot Tc / {C}_{F} \qquad ( 5 )$$

Note that it is assumed that the capacitance C_{L} of the load capacitor 32 is sufficiently larger than the capacitance C_{F} of the flying capacitor 22. In other words, it is assumed that C_{L}>>C_{F} holds. Expression (5) represents that the output voltage Vo=−V₁ may be controlled to be closer or identical to a certain voltage through feedback control of time Tc or the voltage V_{F} which the current source 20 outputs.

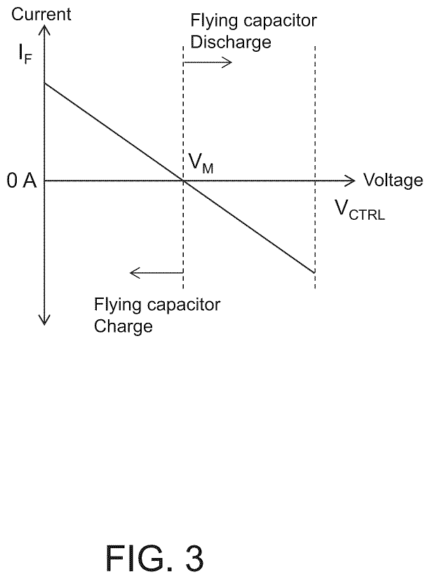

FIG. 3 illustrates control characteristics of the current source 20. The horizontal axis represents the control voltage V_{CTRL}, and the vertical axis represents a charging current I_{F} output from the current source 20. When the control voltage V_{CTRL} is a mid-voltage V_{M}, the charging current I_{F} is 0. When the control voltage V_{CTRL} is greater than the mid-voltage V_{M}, a discharging current of the flying capacitor 22 increases in response to an increase in the control voltage V_{CTRL}. When the control voltage V_{CTRL} is below the mid-voltage V_{M}, the charging current I_{F} of the flying capacitor 22 increases in response to a decrease in the control voltage V_{CTRL}.

The error amplifier 26 increases the control voltage V_{CTRL} to decrease the charging current I_{F} when the output voltage Vo is below the target voltage V_{TARGET}, thereby decreasing the terminal-to-terminal voltage V_{F} of the flying capacitor 22 (the voltage with reference to the voltage on the first end 36 side). The error amplifier 26 decreases the control voltage V_{CTRL} to increase the charging current I_{F} when the output voltage Vo is greater than the target voltage V_{TARGET}, thereby increasing the terminal-to-terminal voltage V_{F} of the flying capacitor 22. The error amplifier 26 sets the control voltage V_{CTRL} at the mid-voltage V_{M} to keep the charging current I_{F} at 0 when the output voltage Vo is identical to the target voltage V_{TARGET}, thereby maintaining the terminal-to-terminal voltage V_{F} of the flying capacitor 22. For the error amplifier 26, a differential amplifier circuit that amplifies a voltage difference between two input voltages and outputs the amplified result, such as an operational amplifier, may be used. In accordance with the control voltage V_{CTRL} which the error amplifier 26 outputs to the current source 20, the output voltage Vo becomes closer or identical to the target voltage V_{TARGET}.

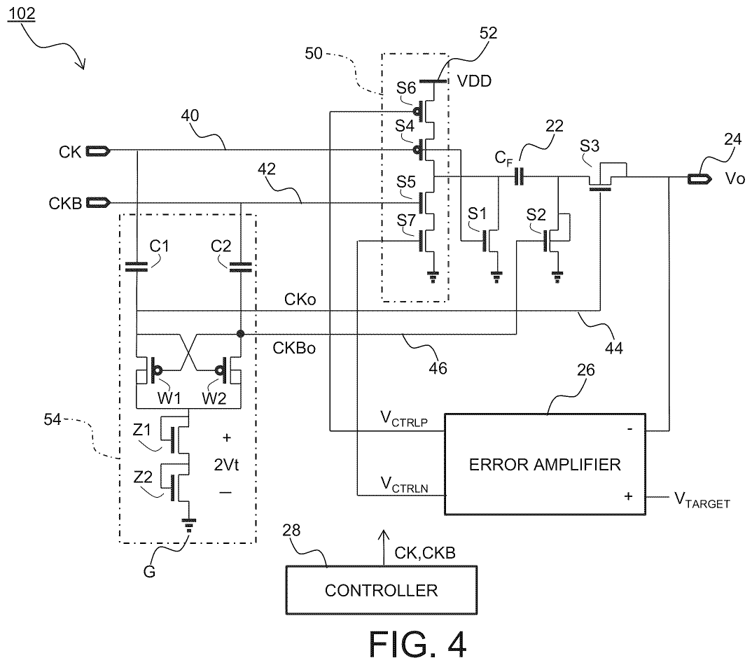

FIG. 4 illustrates the charge pump 102 according to an embodiment of the present disclosure. The charge pump 102 is connected to the grounded conductor G serving as the first reference conductor and a power supply line 52 serving as the second reference conductor. A power supply voltage VDD is provided between the power supply line 52 and the grounded conductor G, and power supply electric power is supplied from the power supply line 52 to the charge pump 102.

In the charge pump 102, the current source 20 and the driver switch 10 of FIG. 1 are composed of a push-pull driver 50. The push-pull driver 50 includes a PMOS switch S4 serving as the fourth switch and an NMOS switch S5 serving as the fifth switch. The push-pull driver 50 further includes a PMOS transistor S6 serving as the first current adjusting device and an NMOS transistor S7 serving as the second current adjusting device. Note that PMOS is an abbreviation for p-channel metal-oxide semiconductor, and NMOS is an abbreviation for n-channel metal-oxide semiconductor.

The source of the PMOS transistor S6 is connected to the power supply line 52. The drain of the PMOS transistor S6 is connected to the source of the PMOS switch S4. The drain of the PMOS switch S4 is connected to the source of the NMOS switch S5, and the drain of the NMOS switch S5 is connected to the source of the NMOS transistor S7. The drain of the NMOS transistor S7 is connected to the grounded conductor G.

In the charge pump 102, the first switch 11 is composed of an NMOS switch S1. The drain of the NMOS switch S1 is connected to the first end of the flying capacitor 22, and the source of the NMOS switch S1 is connected to the grounded conductor G. The second switch 12 is composed of an NMOS switch S2. The drain of the NMOS switch S2 is connected to the second end of the flying capacitor 22, and the source of the NMOS switch S2 is connected to the grounded conductor G. Further, the third switch 13 is composed of an NMOS switch S3. The source of the NMOS switch S3 is connected to the second end of the flying capacitor 22, and the drain of the NMOS switch S3 is connected to the output terminal 24.

The controller 28 outputs a clock signal CK to a clock path 40 which is connected to the gate of the PMOS switch S4 and the gate of the NMOS switch S1. The clock signal CK is guided to the respective gates of the PMOS switch S4 and the NMOS switch S1. The controller 28 outputs an inverted clock signal CKB to an inverted clock path 42 which is connected to the gate of the NMOS switch S5. The inverted clock signal CKB has a relationship with High and Low inverted with respect to the clock signal CK. The inverted clock signal CKB is guided to the gate of the NMOS switch S5.

A negative charge pump 54 serving as the auxiliary circuit is connected to the clock path 40 and the inverted clock path 42. A second clock path 44 and a second inverted clock path 46 are also connected to the negative charge pump 54. The negative charge pump 54 includes a first voltage-shifting capacitor C1, a second voltage-shifting capacitor C2, a first PMOS switch W1, a second PMOS switch W2, a first NMOS transistor Z1, and a second NMOS transistor Z2.

An upper end of the first voltage-shifting capacitor C1 is connected to the clock path 40, and a lower end of the first voltage-shifting capacitor C1 is connected to the second clock path 44. In other words, the second clock path 44 is connected to the clock path 40 via the first voltage-shifting capacitor C1. The second clock path 44 is connected to the gate of the NMOS switch S3. An upper end of the second voltage-shifting capacitor C2 is connected to the inverted clock path 42, and a lower end of the second voltage-shifting capacitor C2 is connected to the second inverted clock path 46. In other words, the second inverted clock path 46 is connected to the inverted clock path 42 via the second voltage-shifting capacitor C2. The second inverted clock path 46 is connected to the gate of the NMOS switch S2.

The source of the first PMOS switch W1 is connected to the lower end of the first voltage-shifting capacitor C1, and the gate of the first PMOS switch W1 is connected to the lower end of the second voltage-shifting capacitor C2. The source of the second PMOS switch W2 is connected to the lower end of the second voltage-shifting capacitor C2, and the gate of the second PMOS switch W2 is connected to the lower end of the first voltage-shifting capacitor C1.

The drains of the first PMOS switch W1 and the second PMOS switch W2 are connected to the drain of the first NMOS transistor Z1, and the source of the first NMOS transistor Z1 is connected to the drain of the second NMOS transistor Z2. The source of the second NMOS transistor Z2 is connected to the grounded conductor G. The respective gates of the first NMOS transistor Z1 and the second NMOS transistor Z2 are connected to their respective drains. This allows the voltage of the drain of each of the first PMOS switch W1 and the second PMOS switch W2, that is, the voltage of the drain of the first NMOS transistor Z1 to be maintained at 2 Vt.

The voltage Vt herein represents a voltage drop between the drain and the source of each of the first NMOS transistor Z1 and the second NMOS transistor Z2.

The terminal-to-terminal voltage of each of the first voltage-shifting capacitor C1 and the second voltage-shifting capacitor C2 is maintained at VDD−2 Vt. Note that the lower end has a positive voltage with respect to the upper end. As described above, the negative charge pump 54 charges the first voltage-shifting capacitor C1 and the second voltage-shifting capacitor C2 included therein.

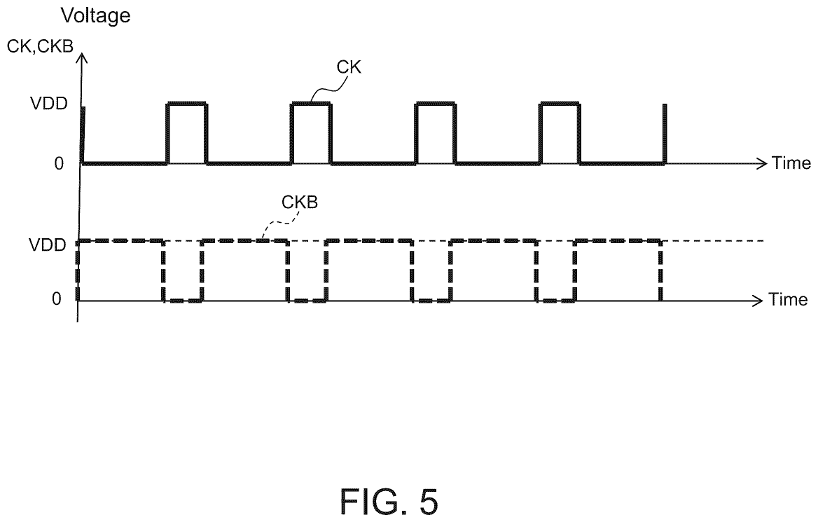

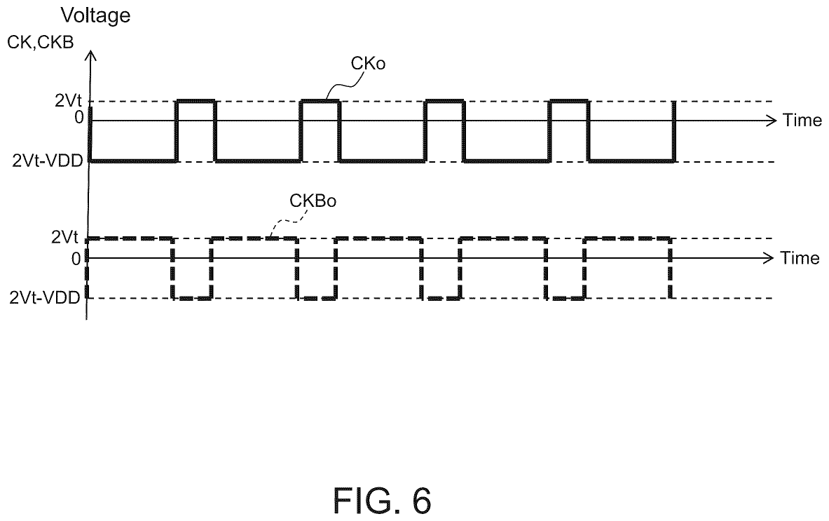

FIG. 5 illustrates, by way of example, a time waveform of the clock signal CK and a time waveform of the inverted clock signal CKB. The clock signal CK is a signal in which High having a voltage VDD and Low having a voltage of 0 are alternately repeated. The inverted clock signal CKB has a relationship with High and Low inverted with respect to the clock signal CK. FIG. 6 illustrates, by way of example, a time waveform of an offset clock signal CKo and a time waveform of an offset inverted clock signal CKBo. The offset clock signal CKo has a dc component that is offset toward a lower voltage with respect to the clock signal CK, and the offset inverted clock signal CKBo has a de component that is offset toward a lower voltage with respect to the inverted clock signal CKB. More specifically, the offset clock signal CKo has a voltage that is lower by VDD−2 Vt with respect to the clock signal CK, and the offset inverted clock signal CKBo has a voltage that is lower by VDD−2 Vt with respect to the inverted clock signal CKB.

The offset clock signal CKo is guided to the gate of the NMOS switch S3 through the second clock path 44. The offset inverted clock signal CKBo is guided to the gate of the NMOS switch S2 through the second inverted clock path 46.

Typically, a PMOS switch is ON when the potential of a gate serving as the control terminal is less than or equal to a threshold value, and OFF when it is greater than the threshold value. An NMOS switch is ON when the potential of a gate serving as the control terminal is greater than or equal to a threshold value, and OFF when it is less than the threshold value. Note that the reference for the potential is the potential of a source.

In response to the clock signal CK being at level Low (0) and the inverted clock signal CKB being at level High (VDD), the PMOS switch S4 and the NMOS switch S5 are ON, and the NMOS switch S2 is also ON. The NMOS switch S1 and the NMOS switch S3 are then OFF. In other words, when the clock signal CK is at level Low (0) and the inverted clock signal CKB is at level High (VDD), the operation phase of the charge pump 102 enters the Φ_{B} phase.

In response to the clock signal CK being at level High (VDD) and the inverted clock signal CKB being at level Low (0), the PMOS switch S4 and the NMOS switch S5 are OFF, and the NMOS switch S2 is also OFF. The NMOS switch S1 and the NMOS switch S3 are then ON. In other words, when the clock signal CK is at level High (VDD) and the inverted clock signal CKB is at level Low (0), the operation phase of the charge pump 102 enters the Φ phase.

As described above, the controller 28 executes a method of controlling the charge pump 102, the method comprising alternately turning ON or OFF the NMOS switch S1 serving as the first switch 11 and the NMOS switch S2 serving as the second switch 12, turning ON or OFF the NMOS switch S3 serving as the third switch 13 together with the NMOS switch S1, and turning ON or OFF the PMOS switch S4 serving as the fourth switch and the NMOS switch S5 serving as the fifth switch together with the NMOS switch S2.

By the action of the negative charge pump 54, the first voltage-shifting capacitor C1, and the second voltage-shifting capacitor C2, the offset clock signal CKo having a voltage that is lower by VDD−2 Vt with respect to the clock signal CK is generated, and through the second clock path 44, the offset clock signal CKo is guided to the gate of the NMOS switch S3. The offset inverted clock signal CKBo having a voltage that is lower by VDD−2 Vt with respect to the inverted clock signal CKB is also generated, and through the second inverted clock path 46, the offset inverted clock signal CKBo is guided to the gate of the NMOS switch S2. This enables reliable switching of the NMOS switches S2 and S3 even if the output voltage Vo is close to 0 or is a negative voltage.

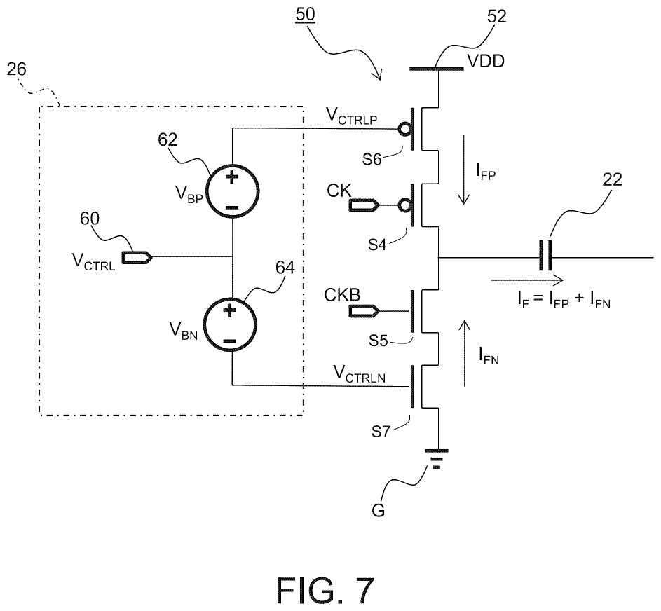

FIG. 7 illustrates the push-pull driver 50 together with a portion of the error amplifier 26. The push-pull driver 50 is configured to approximately implement the characteristics of the current source 20 illustrated in FIG. 3. The error amplifier 26 includes a control terminal 60, a voltage-shifting power supply 62, and a voltage-shifting power supply 64. The voltage-shifting power supply 62 and the voltage-shifting power supply 64 respectively output voltages V_{BP} and V_{BN}.

The control voltage V_{CTRL} is applied to the control terminal 60. Control voltages serving as the control signals are individually output from the error amplifier 26 to the gate of the PMOS transistor S6 and the gate of the NMOS transistor S7, as will next be described. A voltage V_{CTRL}+V_{BP}, which is the control voltage V_{CTRL} plus the output voltage V_{BP} from the voltage-shifting power supply 62, is output to the gate of the PMOS transistor S6. A voltage V_{CTRL}−V_{BN}, which is the control voltage V_{CTRL} minus the output voltage V_{BN} from the voltage-shifting power supply 64, is output to the gate of the NMOS transistor S7.

The error amplifier 26 as described above may be configured using the technique described in Non-Patent Literature 2 identified above.

During the Φ_{B} phase in which the PMOS switch S4 and the NMOS switch S5 are ON, a current I_{FP} flows into the PMOS transistor S6 and the PMOS switch S4 from the power supply line 52, and the current I_{FP} flows from the drain of the PMOS switch S4 toward the first end of the flying capacitor 22. A current I_{FN} flows into the NMOS transistor S7 and the NMOS switch S5 from the grounded conductor G, and the current I_{FN} flows from the source of the NMOS switch S5 toward the first end of the flying capacitor 22. Therefore, in the Φ_{B} phase, the charging current I_{F}=I_{FP}+I_{FN} flows from the push-pull driver 50 toward the flying capacitor 22.

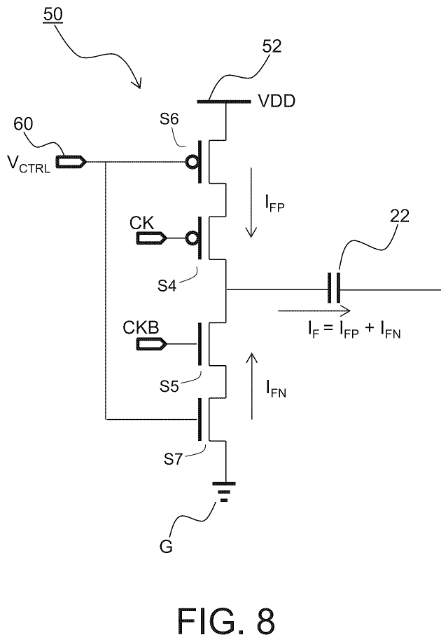

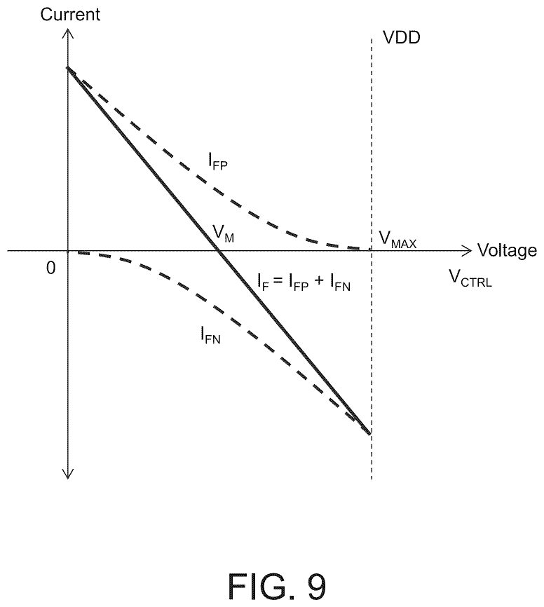

FIG. 8 illustrates a circuit in which the voltage-shifting power supply 62 and the voltage-shifting power supply 64 in the error amplifier 26 illustrated in FIG. 7 are short-circuited. A common control voltage is output from the error amplifier 26 to the gate of the PMOS transistor S6 and the gate of the NMOS transistor S7 as a common control signal. FIG. 9 illustrates a relationship between the charging current I_{F} flowing from the push-pull driver 50 illustrated in FIG. 8 toward the flying capacitor 22 and the control voltage V_{CTRL}. As the control voltage V_{CTRL} increases from 0 to a maximum value V_{MAX}, the charging current I_{F} linearly decreases, so that the charging current I_{F} is 0 when the control voltage V_{CTRL} is at the mid-voltage V_{M}. When the control voltage V_{CTRL} is less than the mid-voltage V_{M}, the charging current I_{F} is positive, thus charging the flying capacitor 22. On the other hand, when the control voltage V_{CTRL} is greater than the mid-voltage V_{M}, the charging current I_{F} is negative, thus discharging the flying capacitor 22.

When the control voltage V_{CTRL} is at the mid-voltage V_{M}, the current I_{FP} flowing into the PMOS transistor S6 and the PMOS switch S4 and the current I_{FN} flowing into the NMOS transistor S7 and the NMOS switch S5 are not 0. These currents may cause power loss. In other words, while no current flows into the flying capacitor 22, a current flows into the push-pull driver 50, which may cause power loss.

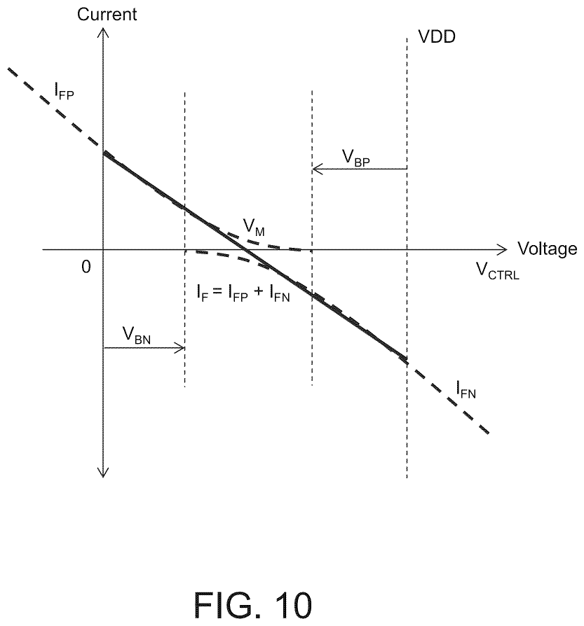

To address this, the error amplifier 26 according to an embodiment of the present disclosure may include the voltage-shifting power supply 62 and the voltage-shifting power supply 64 as illustrated in FIG. 7. The control voltage V_{CTRL} plus the output voltage V_{BP} from the voltage-shifting power supply 62, the voltage V_{CTRL}+V_{BP}, is output to the gate of the PMOS transistor S6, and the control voltage V_{CTRL} minus the output voltage V_{BN} from the voltage-shifting power supply 64, the voltage V_{CTRL}−V_{BN}, is output to the gate of the NMOS transistor S7. This causes the current I_{FP} to move by the voltage V_{BP} in the negative direction and causes the current I_{FN} to move by the voltage V_{BN} in the positive direction, as illustrated in FIG. 10. When the control voltage V_{CTRL} is at the mid-voltage V_{M}, the current I_{FP} flowing into the PMOS transistor S6 and the PMOS switch S4 and the current I_{FN} flowing into the NMOS transistor S7 and the NMOS switch S5 are made closer to 0, resulting in a reduction in power loss.

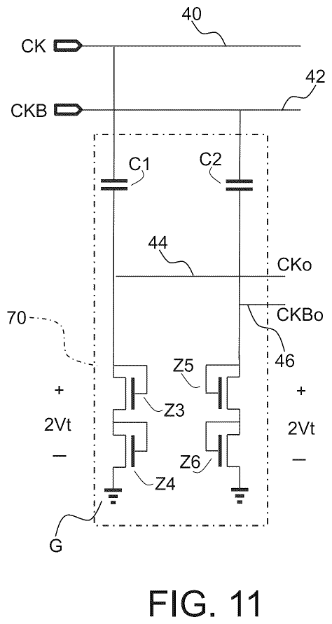

In the above-described embodiment, the negative charge pump 54 is connected to the clock path 40 and the inverted clock path 42, and the second clock path 44 and the second inverted clock path 46 are connected to the negative charge pump 54. Instead of the negative charge pump 54, as illustrated in FIG. 11, a voltage-shifting circuit 70 may be connected to the clock path 40 and the inverted clock path 42, and the second clock path 44 and the second inverted clock path 46 may be connected to the voltage-shifting circuit 70. The voltage-shifting circuit 70 includes the first voltage-shifting capacitor C1, the second voltage-shifting capacitor C2, a third NMOS transistor Z3, a fourth NMOS transistor Z4, a fifth NMOS transistor Z5, and a sixth NMOS transistor Z6. The voltage-shifting circuit 70 also serves as the auxiliary circuit that charges the first voltage-shifting capacitor C1 and the second voltage-shifting capacitor C2 included therein.

The drain of the third NMOS transistor Z3 is connected to the lower end of the first voltage-shifting capacitor C1. The source of the third NMOS transistor Z3 is connected to the drain of the fourth NMOS transistor Z4. The source of the fourth NMOS transistor Z4 is connected to the grounded conductor G. The drain of the fifth NMOS transistor Z5 is connected to the lower end of the second voltage-shifting capacitor C2. The source of the fifth NMOS transistor Z5 is connected to the drain of the sixth NMOS transistor Z6. The source of the sixth NMOS transistor Z6 is connected to the grounded conductor G. The respective gates of the third NMOS transistor Z3 to the sixth NMOS transistor Z6 are connected to their respective drains.

By the action of the voltage-shifting circuit 70, the terminal-to-terminal voltage of each of the first voltage-shifting capacitor C1 and the second voltage-shifting capacitor C2 is maintained at VDD−2 Vt. Note that the lower end has a positive voltage with respect to the upper end. With this configuration, when the clock signal CK and the inverted clock signal CKB as illustrated in FIG. 5 are respectively supplied to the clock path 40 and the inverted clock path 42, the offset clock signal CKo and the offset inverted clock signal CKBo as illustrated in FIG. 6 are respectively supplied to the second clock path 44 and the second inverted clock path 46.

In the charge pump 102 according to an embodiment of the present disclosure, the push-pull driver 50 for charging or discharging the flying capacitor 22 is used. The charging voltage V_{F} of the flying capacitor 22 may be either a positive voltage or a negative voltage. Therefore, regardless of whether the output voltage Vo is higher or lower than the target voltage V_{TARGET}, the output voltage Vo becomes closer or identical to the target voltage V_{TARGET}. The output voltage Vo may be either a positive voltage or a negative voltage. With this configuration, an image sensor is controlled appropriately.

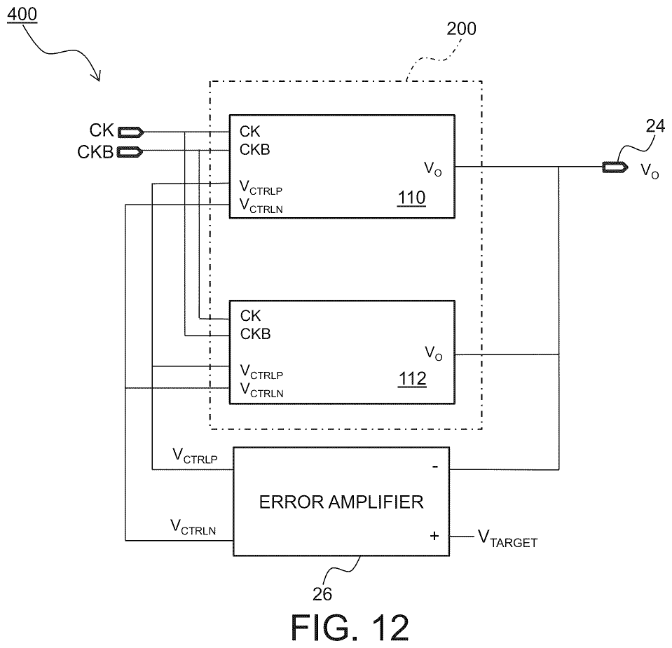

FIG. 12 illustrates a configuration of a charge pump system 400 according to a first application embodiment of the present disclosure. The charge pump system 400 includes the error amplifier 26 and a charge pump unit 200. The charge pump unit 200 includes a first charge pump 110 and a second charge pump 112. The first charge pump 110 and the second charge pump 112 each have a configuration similar to that of the charge pump 102 illustrated in FIG. 4. The output terminal 24 of the first charge pump 110 and the output terminal 24 of the second charge pump 112 are connected in common.

The clock signal CK and the inverted clock signal CKB are input in common to the first charge pump 110 and the second charge pump 112. The error amplifier 26 controls the first charge pump 110 and the second charge pump 112 in common. Specifically, control voltages V_{CTRLP} and V_{CTRLN} that reduce the magnitude of a difference value obtained when the output voltage Vo is subtracted from the target voltage V_{TARGET} are output to the first charge pump 110 and the second charge pump 112.

In accordance with the control voltages V_{CTRLP} and V_{CTRLN} which the error amplifier 26 outputs to the first charge pump 110 and the second charge pump 112, the output voltage Vo becomes closer or identical to the target voltage V_{TARGET}.

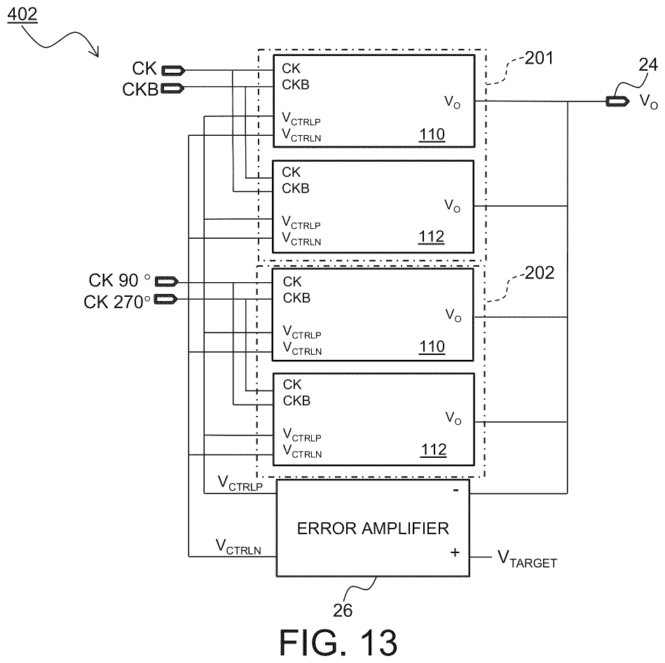

FIG. 13 illustrates a configuration of a charge pump system 402 according to a second application embodiment of the present disclosure. The charge pump system 402 includes the error amplifier 26, a first charge pump unit 201, and a second charge pump unit 202. The first charge pump unit 201 and the second charge pump unit 202 each have a configuration similar to that of the charge pump unit 200 illustrated in FIG. 12. The output terminal 24 of the first charge pump unit 201 and the output terminal 24 of the second charge pump unit 202 are connected in common.

The clock signal CK and the inverted clock signal CKB are input to the first charge pump unit 201. Instead of the clock signal CK and the inverted clock signal CKB, a clock signal CK90° and the clock signal CK270° are input to the second charge pump unit 202. The clock signal CK90° is a signal having a phase delay of 90 degrees with respect to the clock signal CK. The clock signal CK270° is a signal having a phase delay of 90 degrees with respect to the inverted clock signal CKB. The clock signal CK90° may be a signal having a phase lead of 90 degrees with respect to the clock signal CK, and in this case, the clock signal CK270° is a signal having a phase lead of 90 degrees with respect to the inverted clock signal CKB.

The error amplifier 26 controls the first charge pump unit 201 and the second charge pump unit 202 in common. Specifically, the control voltages V_{CTRLP} and V_{CTRLN} that reduce the magnitude of a difference value obtained when the output voltage Vo is subtracted from the target voltage V_{TARGET} are output to the first charge pump unit 201 and the second charge pump unit 202.

In accordance with the control voltages V_{CTRLP} and V_{CTRLN} which the error amplifier 26 outputs to the first charge pump unit 201 and the second charge pump unit 202, the output voltage Vo becomes closer or identical to the target voltage V_{TARGET}.

As described above, the charge pump system 400 according to the first application embodiment of the present disclosure and the charge pump system 402 according to the second application embodiment of the present disclosure each include a plurality of charge pumps 102 to which the output terminal 24 is connected in common. The clock signal CK and the inverted clock signal CKB for controlling the switches included in each of the plurality of charge pumps 102 are input to each of the plurality of charge pumps 102. As can be seen in the charge pump system 402 according to the second application embodiment, the clock signal CK and the inverted clock signal CKB may have different phases for each of the plurality of charge pumps 102. As the clock signal CK and the inverted clock signal CKB have different phases for each of the plurality of charge pumps 102, the processing of making the output voltage Vo closer to the target voltage V_{TARGET} is performed more frequently. Thus, the output voltage Vo reliably becomes closer or identical to the target voltage V_{TARGET}.

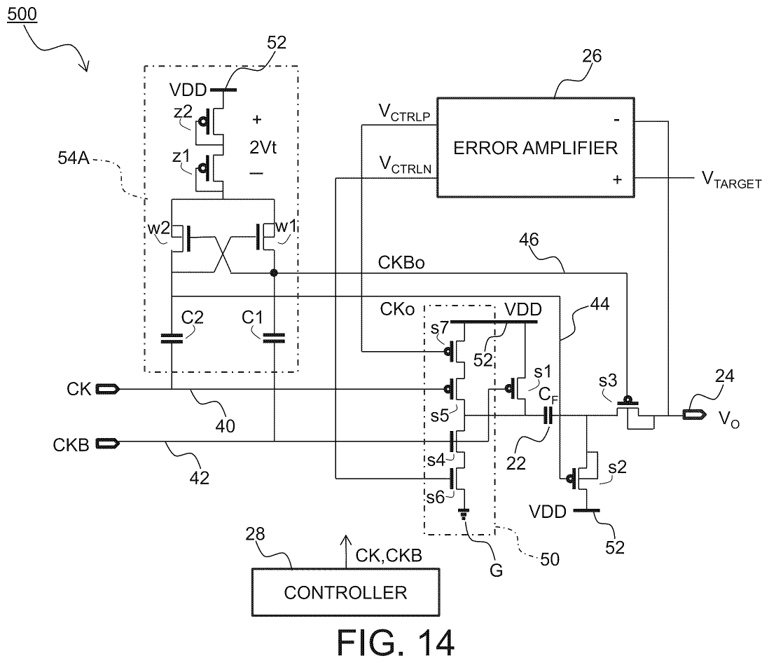

FIG. 14 illustrates a PN-substituted charge pump 500 according to a modification example of the present disclosure. The PN-substituted charge pump 500 outputs a voltage that is higher than the power supply voltage VDD. In the PN-substituted charge pump 500, an NMOS switch is substituted for a PMOS switch of the charge pump 102 illustrated in FIG. 4 which outputs a voltage that is lower than the voltage of the grounded conductor G, and a PMOS switch is substituted for an NMOS switch of the charge pump 102. Also, an NMOS transistor is substituted for a PMOS transistor of the charge pump 102, and a PMOS transistor is substituted for an NMOS transistor of the charge pump 102. Further, the grounded conductor G is substituted for the power supply line 52 of the charge pump 102, and the grounded conductor G serves as the second reference conductor. Also, the power supply line 52 is substituted for the grounded conductor G of the charge pump 102, and the power supply line 52 serves as the first reference conductor. Additionally, the inverted clock signal CKB is substituted for the clock signal CK of the charge pump 102, and the clock signal CK is substituted for the inverted clock signal CKB of the charge pump 102. Thus, the offset inverted clock signal CKBo is substituted for the offset clock signal CKo of the charge pump 102, and the offset clock signal CKo is substituted for the offset inverted clock signal CKBo of the charge pump 102. Also, in the PN-substituted charge pump 500, the control voltages V_{CTRLN} and V_{CTRLP} are respectively substituted for the control voltages V_{CTRLP} and V_{CTRLN} of the charge pump 102.

More specifically, in the PN-substituted charge pump 500, PMOS switches s1 to s3 and s5 are respectively substituted for the NMOS switches S1 to S3 and S5 of the charge pump 102. In the PN-substituted charge pump 500, an NMOS switch s4 is substituted for the PMOS switch S4 of the charge pump 102. In the PN-substituted charge pump 500, an NMOS transistor s6 and a PMOS transistor s7 are respectively substituted for the PMOS transistor S6 and the NMOS transistor S7 of the charge pump 102. In the PN-substituted charge pump 500, a negative charge pump 54A is substituted for the negative charge pump 54 of the charge pump 102. Specifically, in the negative charge pump 54A, a first NMOS switch w1 and a second NMOS switch w2 are respectively substituted for the first PMOS switch W1 and the second PMOS switch W2 of the negative charge pump 54. In the negative charge pump 54A, a first PMOS transistor z1 and a second PMOS transistor z2 are respectively substituted for the first NMOS transistor Z1 and the second NMOS transistor Z2 of the negative charge pump 54.

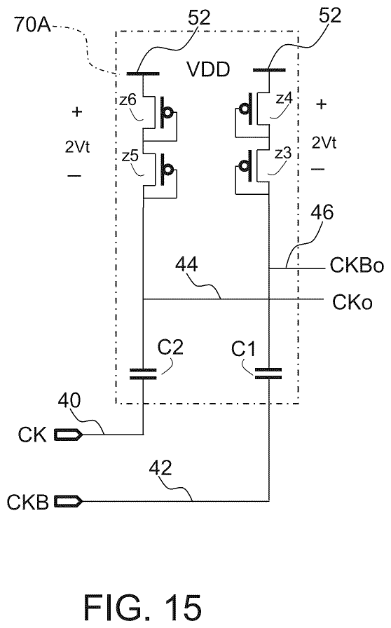

A voltage-shifting circuit 70A illustrated in FIG. 15 is substituted for the voltage-shifting circuit 70 (FIG. 11) that is used in place of the negative charge pump 54 of the charge pump 102. Specifically, in the voltage-shifting circuit 70A, a third PMOS transistor z3, a fourth PMOS transistor z4, a fifth PMOS transistor z5, and a sixth PMOS transistor z6 are respectively substituted for the third NMOS transistor Z3, the fourth NMOS transistor Z4, the fifth NMOS transistor Z5, and the sixth NMOS transistor Z6 of the voltage-shifting circuit 70.

The PN-substituted charge pump 500 is a modification of the charge pump 102, in which a semiconductor device, in which holes serve as carriers, is substituted for a semiconductor device in which electrons serve as carriers, and a semiconductor device in which electrons serve as carriers is substituted for a semiconductor device in which holes serve as carriers. Therefore, the PN-substituted charge pump 500 operates in a similar manner as for the charge pump 102.

1. A charge pump comprising:
a flying capacitor;
a push-pull driver provided on a first end of the flying capacitor;
a first switch provided between the first end of the flying capacitor and a first reference conductor;
a second switch provided between a second end of the flying capacitor and the first reference conductor; and
a third switch provided between the second end of the flying capacitor and an output terminal,
wherein the push-pull driver comprises a fourth switch and a fifth switch, each of the fourth switch and the fifth switch having a first end connected to the first end of the flying capacitor, and
wherein the fourth switch has a second end connected to a second reference conductor, the second reference conductor being different from the first reference conductor, and the fifth switch has a second end connected to the first reference conductor.

2. The charge pump according to claim 1, comprising a controller configured to control the push-pull driver, the first switch, the second switch, and the third switch,
wherein the controller is configured to:
alternately turn the first switch and the second switch ON or OFF;
turn the third switch ON or OFF together with the first switch; and
turn the fourth switch and the fifth switch ON or OFF together with the second switch.

3. The charge pump according to claim 1,
wherein the push-pull driver comprises:
a first current adjusting device provided on the second end of the fourth switch; and
a second current adjusting device provided on the second end of the fifth switch,
wherein the first current adjusting device and the second current adjusting device are configured to adjust a current that flows into the flying capacitor.

4. The charge pump according to claim 3, comprising an error amplifier configured to:
output a common control signal to the first current adjusting device and the second current adjusting device in accordance with a difference between an output voltage at the output terminal and a target voltage; and
adjust a current that flows into the first current adjusting device and the fourth switch and a current that flows into the second current adjusting device and the fifth switch.

5. The charge pump according to claim 3, comprising an error amplifier configured to:
individually output control signals to respective ones of the first current adjusting device and the second current adjusting device in accordance with a difference between an output voltage at the output terminal and a target voltage; and
adjust a current that flows into the first current adjusting device and the fourth switch and a current that flows into the second current adjusting device and the fifth switch.

6. The charge pump according to claim 1, comprising:
a clock path that guides a clock signal to a control terminal of the fourth switch;
an inverted clock path that guides an inverted clock signal to a control terminal of the fifth switch, the inverted clock signal having a relationship with High and Low inverted with respect to the clock signal;
a second clock path connected to the clock path via a first voltage-shifting capacitor; and
a second inverted clock path connected to the inverted clock path via a second voltage-shifting capacitor,
wherein an offset clock signal having a dc component that is offset with respect to the clock signal is guided to a control terminal of the third switch through the second clock path, and
wherein an offset inverted clock signal having a dc component that is offset with respect to the inverted clock signal is guided to a control terminal of the second switch through the second inverted clock path.

7. The charge pump according to claim 6, comprising an auxiliary circuit which includes the first voltage-shifting capacitor and the second voltage-shifting capacitor, and to which the second clock path and the second inverted clock path are connected,
wherein the auxiliary circuit charges the first voltage-shifting capacitor and the second voltage-shifting capacitor.

8. The charge pump according to claim 1,
wherein the first switch, the second switch, the third switch, and the fifth switch are NMOS switches, and
wherein the fourth switch is a PMOS switch.

9. The charge pump according to claim 8,
wherein the first reference conductor is a grounded conductor, and
wherein the second reference conductor is a power supply line.

10. The charge pump according to claim 1,
wherein the first switch, the second switch, the third switch, and the fifth switch are PMOS switches, and
wherein the fourth switch is an NMOS switch.

11. The charge pump according to claim 10,
wherein the first reference conductor is a power supply line, and
wherein the second reference conductor is a grounded conductor.

12. A charge pump system comprising a plurality of charge pumps, each of the plurality of charge pumps comprising:
a flying capacitor;
a push-pull driver provided on a first end of the flying capacitor;
a first switch provided between the first end of the flying capacitor and a first reference conductor;
a second switch provided between a second end of the flying capacitor and the first reference conductor; and
a third switch provided between the second end of the flying capacitor and an output terminal,
wherein the push-pull driver comprises a fourth switch and a fifth switch, each of the fourth switch and the fifth switch having a first end connected to the first end of the flying capacitor,
wherein the fourth switch has a second end connected to a second reference conductor, the second reference conductor being different from the first reference conductor, and the fifth switch has a second end connected to the first reference conductor,
wherein the output terminals of the plurality of charge pumps are connected in common,
wherein a clock signal for controlling the first to fifth switches included in each of the plurality of charge pumps is input to each of the plurality of charge pumps, and
wherein the clock signal has a different phase for each of the plurality of charge pumps.

13. A method of controlling a charge pump, the charge pump comprising:
a flying capacitor;
a push-pull driver provided on a first end of the flying capacitor;
a first switch provided between the first end of the flying capacitor and a first reference conductor;
a second switch provided between a second end of the flying capacitor and the first reference conductor; and
a third switch provided between the second end of the flying capacitor and an output terminal,
wherein the push-pull driver comprises a fourth switch and a fifth switch, each of the fourth switch and the fifth switch having a first end connected to the first end of the flying capacitor, and
wherein the fourth switch has a second end connected to a second reference conductor, the second reference conductor being different from the first reference conductor, and the fifth switch has a second end connected to the first reference conductor,
the method comprising:
alternately turning the first switch and the second switch ON or OFF;
turning the third switch ON or OFF together with the first switch; and
turning the fourth switch and the fifth switch ON or OFF together with the second switch.

14. The method according to claim 13,
wherein the push-pull driver comprises:
a first current adjusting device provided on the second end of the fourth switch; and
a second current adjusting device provided on the second end of the fifth switch,
the method comprising:
causing the first current adjusting device and the second current adjusting device to adjust a current that flows into the flying capacitor.

15. The method according to claim 14, comprising:
outputting a common control signal to the first current adjusting device and the second current adjusting device in accordance with a difference between an output voltage at the output terminal and a target voltage; and
adjusting a current that flows into the first current adjusting device and the fourth switch and a current that flows into the second current adjusting device and the fifth switch.

16. The method according to claim 14, comprising:
individually outputting control signals to respective ones of the first current adjusting device and the second current adjusting device in accordance with a difference between an output voltage at the output terminal and a target voltage; and
adjusting a current that flows into the first current adjusting device and the fourth switch and a current that flows into the second current adjusting device and the fifth switch.

17. The method according to claim 13, comprising:
providing a clock path that guides a clock signal to a control terminal of the fourth switch;
providing an inverted clock path that guides an inverted clock signal to a control terminal of the fifth switch, the inverted clock signal having a relationship with High and Low inverted with respect to the clock signal;
providing a second clock path connected to the clock path via a first voltage-shifting capacitor;
providing a second inverted clock path connected to the inverted clock path via a second voltage-shifting capacitor;
guiding an offset clock signal to a control terminal of the third switch through the second clock path, the offset clock signal having a dc component that is offset with respect to the clock signal; and
guiding an offset inverted clock signal to a control terminal of the second switch through the second inverted clock path, the offset inverted clock signal having a dc component that is offset with respect to the inverted clock signal.

18. The method according to claim 17, comprising:
connecting an auxiliary circuit to the second clock path and the second inverted clock path, the auxiliary circuit including the first voltage-shifting capacitor and the second voltage-shifting capacitor, wherein the auxiliary circuit charges the first voltage-shifting capacitor and the second voltage-shifting capacitor included therein.

19. The method according to claim 13,
wherein the first switch, the second switch, the third switch, and the fifth switch are NMOS switches, and
wherein the fourth switch is a PMOS switch.

20. The method according to claim 13,
wherein the first switch, the second switch, the third switch, and the fifth switch are PMOS switches, and
wherein the fourth switch is an NMOS switch.
